(19) United States
(12) Patent Application Publication
(10) Pub. No.: US 2008/0142162 A1
(43) Pub. Date: Jun. 19, 2008

(54) Device for Dispensing Labels

(76) Inventor: Jens Storm-Nielsen, Holbaek (DK)

Correspondence Address: FITCH EVEN TABIN AND FLANNERY, 120 SOUTH LA SALLE STREET, SUITE 1600, CHICAGO, IL, 60603-3406, US

(21) Appl. No.: 11/817,372

(22) PCT Filed: Mar. 31, 2006
(86) PCT No.: PCT/DK06/00182

§ 371 Date: Aug. 29, 2007

(51) Int. Cl. B65C 9/08

(52) U.S. Cl. 156/391

(57) ABSTRACT

The present invention relates to a device (1) for dispensing a plurality of labels onto a folio across a travelling path of the folio through the device, said device comprising a supply (2) of labels, which labels are carried by a carrier (21); a guide system (3) for guiding the carrier (21) with labels from the supply (2) to a dispensing means (4). Said dispensing means (4) comprising an arm (5), which extends across the folio, and a dispensing wagon (6), which is arranged on the arm and is adapted to dispense the labels onto the folio while moving along the arm. The device furthermore comprises means (11) for keeping the carrier with a predetermined stretch, said means being arranged between the supply (2) and the dispensing means (4).

### FIELD OF THE INVENTION

The present invention relates to a device for dispensing a plurality of labels onto a folio across a travelling path of the folio through the device, said device comprising a supply of labels, which labels are carried by a carrier; a guide system for guiding the carrier with labels from the supply to a dispensing means. Said dispensing means comprising an arm, which extends across the folio, and a dispensing wagon, which is arranged on the arm and is adapted to dispense the labels onto the folio while moving along the arm.

### BACKGROUND ART

In the prior art cross web labelling machines are known. These machines are adapted to dispense labels onto a folio or other packaging material.

Dispensing of labels in these known machines is often performed by the labels are supplied to a dispensing area. At this area the labels are removed from the carrier and transported to an application place often via a so-called vacuum box, which are well-known in the art. After being transported to the application place the labels are applied to the folio, where after the procedure is repeated with new labels.

This known method have the following disadvantages; the positioning of the labels during their transport to the application place is unstable, i.e. there is a great risk of the labels not are applied correctly to the folio; the application of the labels to the folio is performed by applying the labels substantially perpendicular to the surface of the folio with the entire label surface at once, i.e. there is a risk that there will be air bubbles between the labels and the folio, which furthermore may provide a contaminated, non-hygienic label, which especially is unwanted when the packaging material is being used to food stuff or medical devices or medicines; during the period from the carrier to the application the labels are exposed to air which also may contaminate the adhesion surface between the label and the folio, this is especially a problem when the label is of the type which is adapted to be peelable, i.e. it can be lifted and replaced on the folio several times; the adhesion surface of the label is exposed which may have the consequence that the labels crease and stick to things during stop in the operation, which thereby may require cleaning of the machine before the operation is resumed, also there may be a high waste of labels.

### SUMMARY OF THE INVENTION

An object of the present invention is to wholly or partly overcome the above disadvantages and drawbacks of the prior art. More specifically, it is an object to provide a device for dispensing a plurality of labels onto a folio across a travelling path of the folio through the device.

It is also an object of the present invention to provide a device which have a high operation durability and which have a small amount of waste of labels during stop in the operation.

Another object of the present invention is to provide a device which substantially avoids air bubbles between the label and the folio.

A further object of the present invention is to provide a device wherein the adhesion surface of the label not is exposed to air before being dispensed onto the folio.

The above objects, together with numerous other objects, advantages and features, which will become evident from the below description, are accomplished by a solution in accordance with the present invention by means for keeping the carrier with a predetermined stretch is arranged between the supply and the dispensing means.

Hereby, a device which can dispense a high number of labels on a short period of time without the carrier being damaged is obtained. Also, the labels are dispensed directly from the carrier onto the folio without substantially being disposed to air, whereby a dispensed hygienic label is obtained, which especially is required when being used to foodstuffs as well as medicine.

In a preferred embodiment according to the invention a buffer unit for containing a supply of labels may be arranged in connection with the means for keeping the carrier with the predetermined stretch. Hereby is obtained that the inertia of the supply, which often is in the form of a roll, is avoided.

In an expedient embodiment according to the invention a storing unit for the empty carrier may be arranged in connection with the dispensing means.

According to the invention means for keeping the empty carrier with a predetermined stretch may be arranged between the dispensing means and the storing unit, said means preferably being connected to the means arranged between the supply and the dispensing means. Hereby is obtained that the carrier also is stretched after the labels have been dispensed. Additional it is important that the carrier is stretched so that there not will be any slack in the carrier during dispensing as this will influence the continuously operation of the device, in worst case the carrier may be damaged which will cause stop in the labelling procedure.

Advantageously, the means for keeping the carrier with the predetermined stretch may comprise a slide, which is in connection with a drive means, said slide being adapted to move forth and back in relation to the forth and back movement of the dispensing wagon on the arm, thereby continuously changing the distance between the supply and the dispensing wagon in relation to the instantaneous position of the dispensing wagon on the arm.

Furthermore, the drive means may be a servo motor, said servo motor being adapted to move the slide forth and back by means of a precision belt. During operation of the device it is of high importance that the clearance of the dispensing wagon is reduced to an almost imperceptible level as if the clearance is too big this will result in inaccurate positioning of the labels on the folio. This may advantageously be avoided by using a precision belt according to the invention.

According to the invention the buffer unit may also comprise a slide, which is in connection with a drive means, said slide being adapted to move forth and back in relation to the forth and back movement of the dispensing wagon on the arm as well as the slide, thereby continuously changing the distance between the supply and the dispensing wagon so that the supply of labels contained in the buffer unit at all times relates the instantaneous dispensing need of labels at the dispensing wagon.

Advantageously according to the invention a control unit may be arranged, said control unit being adapted to control the dispense of labels in relation to the speed of the folio as well as to the speed of the movement of the slides.

Also according to the invention a printer may be arranged in connection with guiding system of the carrier so that information is printed on the labels before they are being dispensed. Such information may for instance be a packaging date, expiration date, price, etc.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows the device according to the invention,

FIG. 2 shows the front of the device according to the invention in a perspective view,

FIG. 3 shows the back of the device in a perspective view,

FIG. 4 shows the device according to the invention in a starting position ready for dispensing labels, and

FIG. 5 shows the device in an end position after having dispensed labels across a folio.

All the figures are highly schematic and not necessarily to scale, and they show only parts which are necessary in order to elucidate the invention, other parts being omitted or merely suggested.

### DESCRIPTION OF PREFERRED EMBODIMENTS

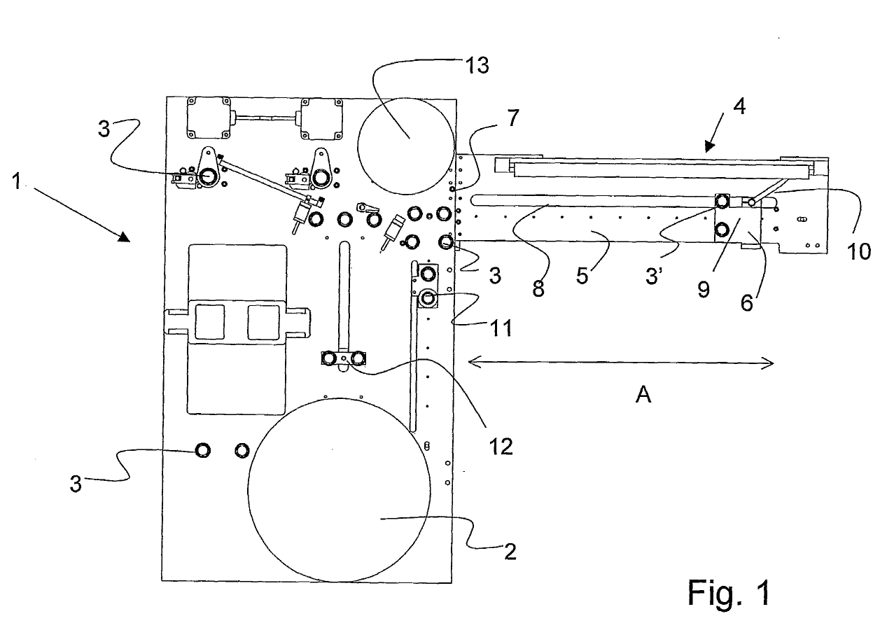

An preferred embodiment of the device 1 according to the present invention is shown in FIG. 1. The device 1 is to be used in connection with dispensing a plurality of labels onto a folio (not shown) across a travelling path of the folio through the device.

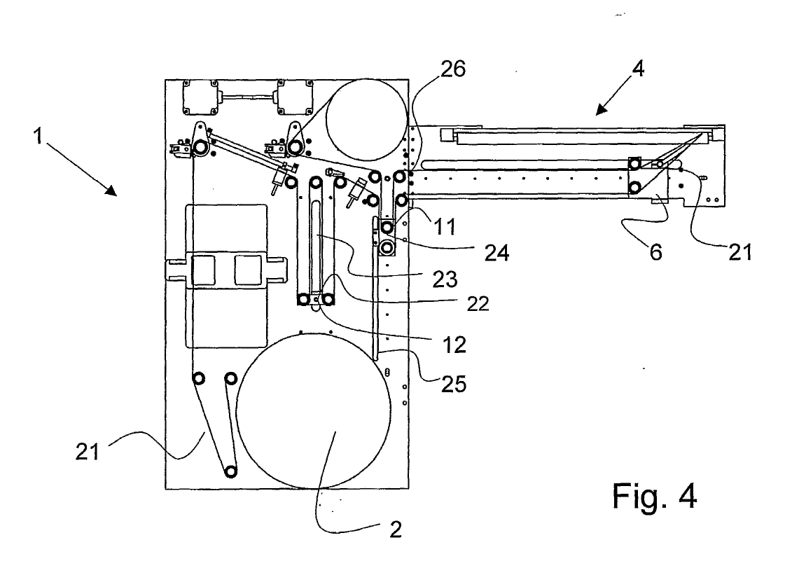

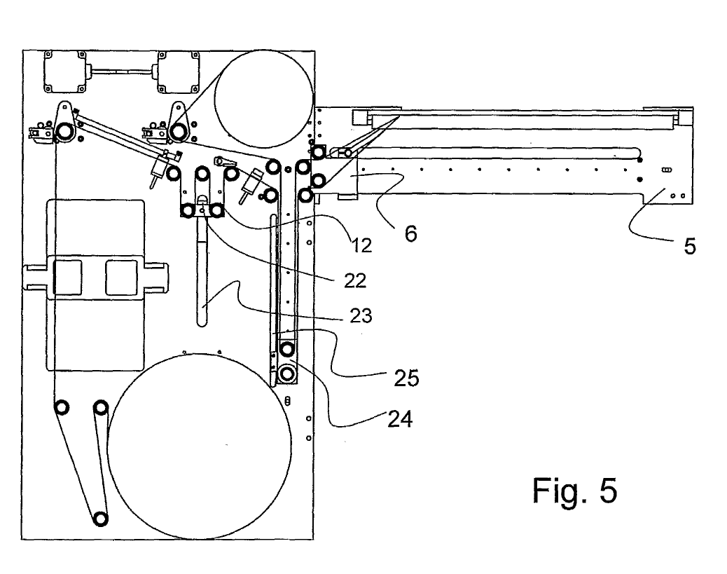

The device 1 comprises a supply 2 of labels, which labels are carried by a carrier (not shown) and a guide system 3 for guiding the carrier with labels from the supply 2 to a dispensing means 4. The guide system 3 consists of a plurality of rollers 3, which are placed so that they serve as turning points for the carrier, during its travel from the supply 2 to the dispensing means 4. The rollers 3 are adapted to be rotable. In FIGS. 4 and 5 the device 1 is shown with a carrier mounted in the device 1 and the guidance of the carrier will be explained further in relation to these figures.

The dispensing means 4 comprises an arm 5, which extends across the folio (not shown), and a dispensing wagon 6, which is arranged on the arm 5 and is adapted to dispense the labels onto the folio while moving along the arm 5.

In this embodiment according to the invention the folio is arranged to travel through the device 1 above the dispensing wagon 6 so that the labels will be dispensed onto the folio from below. However, which will be appreciated by a skilled person the dispensing means may as well be arranged to dispense labels from above.

The extension of the arm 5 is adapted to the breadth of the folio, onto which labels are to dispensed. The arm 5 have rigid and firm connection 7 to the rest of the device 1 so that the positioning of the arm in relation to folio is precise. Furthermore, it is important that the arm is made of a rigid material so that any movements or vibrations of the arm during operation of the device is avoided or at least reduced to a minimum, which thereby will have no influence on the positioning of the labels on the folio.

In addition, the arm 5 is arranged with a groove 8 wherein the dispensing wagon 6 is adapted to be driven forth and back, which is indicated by the arrow A. It is within the inventive idea that the guidance of the dispensing wagon may be carried out in other ways, for instance by using a rail.

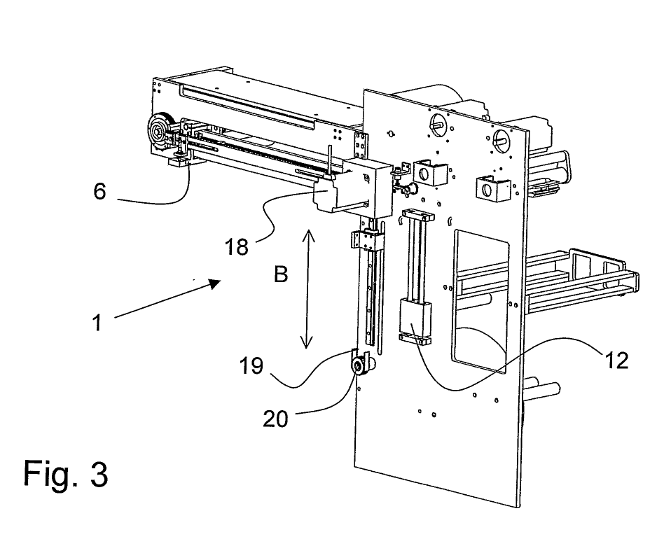

The dispensing wagon 6 is driven forth and back on the arm 5 by means of a motor, preferably a servo motor, which will be explained further in relation to FIG. 3. The dispensing wagon 6 comprises a chassis 9 as well as two rollers 3′ and applying means 10, here in the form of a tongue.

According to the invention the device 1 also comprises means 11 for keeping the carrier with a predetermined stretch, which means is arranged between the supply 2 and the dispensing means 4. The function of this means will be explained further in connection with FIGS. 4 and 5.

The device 1 further comprises a buffer unit 12 for containing a supply of labels, which buffer unit 12 being arranged in connection with the means 11 for keeping the carrier with the predetermined stretch. The function of this buffer unit will be explained further in connection with FIGS. 4 and 5.

A storing unit 13 for the empty carrier is arranged in connection with the dispensing means 4. Advantageously, means 11 for keeping the empty carrier with a predetermined stretch is arranged between the dispensing means 4 and the storing unit 13, said means preferably being connected to the means 11 arranged between the supply 2 and the dispensing means 4.

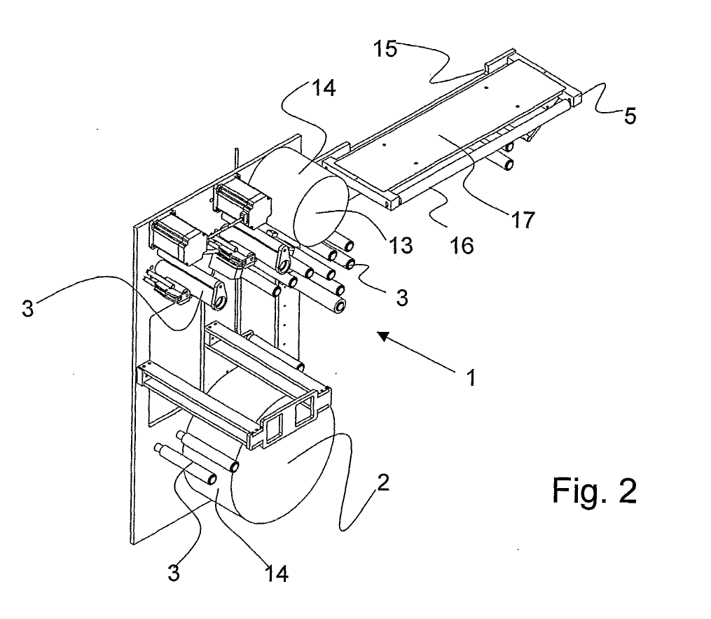

In FIG. 2 the device 1 according to the invention is shown in perspective. From this view it is seen that the rollers 3 have a larger extension than the breadth of the carrier carrying the labels which is indicated by the breadths 14 of the supply 2 and the storing unit 13.

The arm 5 also comprise a recess 15 and a roller 16 for guiding the folio (not shown) through the arm 5. Furthermore, a support surface 17 is arranged for providing support for the folio when the label is being dispensed onto the folio by means of the tongue.

In FIG. 3 is the device 1 shown in perspective seen from the back. On the back of the device the drive means for the means 11, the dispensing wagon 6 as well as buffer unit 12 are arranged.

The drive means for the means 11 is preferably a servo motor 18, said servo motor 18 being adapted to move a slide (will be explained further in connection with FIGS. 4 and 5) forth and back, as indicated by arrow B, by means of a precision belt 19. The precision belt is in this embodiment only shown partly extending around a lower turning point 20, but extends, of cause, all the way up the motor 18. By using a precision belt, instead of for instance a normal cogged V-belt, a high precision of the movement of the slide is obtained, which furthermore limit the clearance of the device so precise positioning of the labels onto the folio is obtained.

The drive means may furthermore drive the buffer unit 12 as well as the dispensing wagon 6 which will be appreciated by the skilled person.

In FIG. 4 the device 1 is shown having the carrier 21 mounted and guided through the device 1. The dispensing wagon 6 being in a first position ready for dispensing labels onto a folio.

In this first position the buffer unit 12 contains a supply of labels, which is seen by the slide 22 is placed in the lowest position of the groove 23 wherein the slide 22 is adapted to move. The matter is that when the slide 22 is in this low position the distance the carrier 21 have to travel from the supply 2 to the dispensing means 4 have been extended. By this extension a supply of labels close to the dispensing means 4 is obtained, whereby the inertia of the label roll in the supply 2 not is relevant.

Furthermore, in this first position the means 11 for keeping the carrier with the predetermined stretch comprises a slide 24, which is in connection with the drive means 18. The slide 24 is adapted to move forth and back in relation to the forth and back movement of the dispensing wagon 6 on the arm 5, thereby continuously changing the distance between the supply 2 and the dispensing wagon 6 in relation to the instantaneous position of the dispensing wagon 6 on the arm 5. The slide 24 is being moved in a groove 25. In this first position the slide 24 is in the uppermost position of the groove 25.

During operation of the device 1 the folio, which is to be labelled, is led to the device 1, i.e. the arm 5. When the folio reach a predetermined position, i.e. the position where the labels are to be placed, its stops and the dispensing wagon 6 starts to move from the first position in the right of FIG. 4 towards left and at the same time dispensing labels from the carrier 21 onto the folio (not shown). During this dispensing of labels the motor which drives the dispensing wagon is adapted to accelerate the dispensing wagon so that the label will be released from the carrier at the end of the tongue 10. An major advantage of the device is that the labels are dispensed directly onto the folio from the carrier without being disposed to the air, so that a hygienic (and thereby not contaminated) area between the label and folio is obtained. A further advantage of the present invention is that the labels are dispensed onto the folio in a sideways manner by means of the tongue 10 whereby substantially no air bubbles are present between the label and the folio.

While the dispensing wagon 6 moves to the left the slide 24 starts to move downwards in the groove 25 whereby the stretch of the carrier at all time is kept at the predetermined value. By this movement of the slide 24 it is also obtained that the empty carrier 26 is kept stretched at a predetermined value, due to the fact that the empty carrier is in connection with said slide 24.

At the same time the slide 22 of the buffer unit 12 is starting to move upwards and thereby changing the distance as well as the supply of labels.

When the dispensing wagon 6 reach a second position, which is shown in FIG. 5, the dispensing wagon 6 have dispensed labels across the entire folio. At this second position, the slide 22 of the buffer unit 12 is in the uppermost position in the groove 23 and the slide 24 is in the lowermost position in the groove 25.

Hereinafter the dispensing wagon 6 will move towards the right of the arm 5, the slide 22 will move downwards (filling the buffer with labels) and slide 24 upwards until they all take the positions shown in FIG. 4 being ready for dispensing a new row of labels onto the folio, which folio have been moved at the same time so that a new part of the folio have be led to the dispensing area.

Furthermore, the device may comprise a control unit (not shown), said control unit being adapted to control the dispense of labels in relation to the speed of the folio as well as to the speed of the movement of the slides 22, 24 and may control the speed of the dispensing wagon.

Even though, the device according to the invention is explained in relation to a single row dispensing device, a number of devices arranged in succession (in row) after each other may be applied.

According to an embodiment of the invention, a printer (not shown) may be arranged in connection with guiding system of the carrier so that information may be printed on the labels before they are being dispensed.

Often the carrier carrying the labels are being made of a paper-like material, wherefore the predetermined stretch of the carrier shall be set so that the carrier not is damaged during its travel through the device, it is vital that the carrier not is being damaged before as well as after dispensing of the labels.

Furthermore, the device according to the invention is easy operable for the user and have a little waste of labels due to the fact that the labels first are removed from the carrier during the actually dispense onto the folio. Thus, the device need substantially no cleaning and a only a little maintenance.

A further advantage is that the device according to the invention may be formed as a kit which easily may be incorporated in existing packaging lines.

Although the invention above has been described in connection with preferred embodiments of the invention, it will be evident for a person skilled in the art that several modifications are conceivable without departing from the invention as defined by the following claims.

1. A device for dispensing a plurality of labels onto a folio across a travelling path of the folio through the device, said device comprising a supply of labels, which labels are carried by a carrier; a guide system for guiding the carrier with labels from the supply to a dispensing means, said dispensing means comprising an arm, which extends across the folio, and a dispensing wagon, which is arranged on the arm and is adapted to dispense the labels onto the folio while moving along the arm wherein means for keeping the carrier with a predetermined stretch is arranged between the supply and the dispensing means.

2. A device according to claim 1, wherein a buffer unit for containing a supply of labels is arranged in connection with the means for keeping the carrier with the predetermined stretch.

3. A device according to claim 1, wherein a storing unit for the empty carrier is arranged in connection with the dispensing means (4).

4. A device according to claim 3, wherein means for keeping the empty carrier with a predetermined stretch is arranged between the dispensing means and the storing unit, said means preferably being connected to the means arranged between the supply and the dispensing means.

5. A device according to claim 1, wherein the means for keeping the carrier with the predetermined stretch comprises a slide, which is in connection with a drive means, said slide being adapted to move forth and back in relation to the forth and back movement of the dispensing wagon on the arm, thereby continuously changing the distance between the supply and the dispensing wagon in relation to the instantaneous position of the dispensing wagon on the arm.

6. A device according to claim 5, wherein the drive means is a servo motor, said servo motor being adapted to move the slide forth and back by means of a precision belt.

7. A device according to claim 2, wherein the buffer unit also comprises a slide, which is in connection with a drive means, said slide being adapted to move forth and back in relation to the forth and back movement of the dispensing wagon on the arm as well as the slide, thereby continuously changing the distance between the supply and the dispensing wagon so that the supply of labels contained in the buffer unit at all time relates the instantaneous dispensing need of labels at the dispensing wagon.

8. A device according to claim 1, wherein a control unit is arranged, said control unit being adapted to control the dispense of labels in relation to the speed of the folio as well as to the speed of the movement of the slides.

9. A device according to claim 1, wherein a printer is arranged in connection with guiding system of the carrier so that information is printed on the labels before they are being dispensed.
